(19) United States
(12) Patent Application Publication
(10) Pub. No.: US 2008/0287611 A1
(43) Pub. Date: Nov. 20, 2008

(54) SILANE VARNISHES COMPRISING AMINOSILANES AND EPOXY-FUNCTIONAL POLYACRYLATES

(75) Inventors: Michael Ludewig, Leverkusen (DE); Burkhard Kohler, Zierenberg (DE); Reinhard Hertrampf, Langenfeld (DE); Christian Wamprecht, Neuss (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/120,852

(22) Filed: May 15, 2008

(30) Foreign Application Priority Data
May 18, 2007 (DE) 102007023282.0

(51) Int. Cl. C08G 65/32; C08G 77/00

(52) U.S. Cl. 525/403; 528/26

(57) ABSTRACT

The invention relates to silane coatings obtainable by reaction of aminosilanes with glycidyl (meth)acrylate copolymers.

### RELATED APPLICATIONS

This application claims benefit to German Patent Application No. 10 2007 023 282±0, filed May 18, 2007, which is incorporated herein by reference in its entirety for all useful purposes.

### BACKGROUND OF THE INVENTION

The invention relates to silane coatings obtainable by reaction of aminosilanes with glycidyl (meth)acrylate copolymers.

JP 2003-337324 describes reaction products of glycidyl methacrylate copolymers with alkylaminosilanes where the secondary amino group on the silane is said to reduce crosslinking during formation. Alkylaminosilanes are industrially less readily available than aminosilanes.

JP 1987-108137 and JP 1985-292453 describe the reaction of glycidyl methacrylate copolymers or allyl glycidyl ether copolymers with adducts of aminosilanes and epoxysilanes.

JP1982-51179 describes the reaction of glycidyl methacrylate copolymers with aminoethylaminopropyltrimethoxysilane. These systems have poor stability in storage.

### EMBODIMENTS OF THE INVENTION

An embodiment of the present invention is a process for preparing alkoxysilyl-containing polymers, comprising A) preparing a glycidyl (meth)acrylate copolymer by polymerizing a) 5% to 40% by weight of glycidyl methacrylate, which is optionally mixed with glycidyl acrylate; b) 50% to 93.9% by weight of vinyl monomers; c) 1% to 20% by weight of mercaptosilanes; and d) 0.1% to 5% by weight of free-radical initiators; and B) reacting said glycidyl (meth)acrylate copolymer with aminoalkyltrialkoxysilanes by at least partial reaction and opening of epoxy groups of the glycidyl (meth)acrylate copolymer.

Another embodiment of the present invention is the above process, wherein said vinyl monomers b) comprise acrylic or methacrylic esters of aliphatic C1-C22 mono-ols, cycloaliphatic C5-C27 mono-ols or araliphatic C7-C14-mono-ols, or tetrahydrofurfuryl alcohol or (poly)ethylene glycol monomethyl ether. Useful vinyl monomers further include styrene, alpha-methylstyrene, 3- or 4-methylstyrene, vinyl acetate, vinyl esters or acrylonitrile.

Another embodiment of the present invention is the above process, wherein c) comprises mercaptopropyltrimethoxysilane.

Another embodiment of the present invention is the above process, wherein said aminoalkyltrialkoxysilanes of B) comprise aminopropyltrialkoxysilanes.

Another embodiment of the present invention is the above process, wherein the ratio of primary amino groups in said aminoalkyltrialkoxysilanes of B) to epoxy groups in said glycidyl (meth)acrylate copolymer obtained in A) is in the range of from 1.2 to 5.

Yet another embodiment of the present invention is an alkoxysilyl-containing polymer prepared by the above process.

Yet another embodiment of the present invention is a coating composition comprising at least one alkoxysilyl-containing polymer prepared by the above process.

### DESCRIPTION OF THE INVENTION

It is an object of the present invention to provide storage-stable silane varnishes obtainable by simple reaction of aminoalkyltrialkoxysilanes with glycidyl methacrylate copolymers.

It has now been found that glycidyl methacrylate copolymers are especially readily formulatable with amino-functional silanes into varnishes when formed using mercaptosilanes for molecular weight regulation.

The invention accordingly provides a process for preparing alkoxysilyl-containing polymers, which comprises
A) a glycidyl methacrylate copolymer being prepared by polymerization of
   a) 5% to 40% by weight of glycidyl methacrylate with or without glycidyl acrylate,
   b) 50% to 93.9% by weight of vinyl monomers,
   c) 1% to 20% by weight of mercaptosilanes, and
   d) 0.1% to 5% by weight of free-radical initiators
      and subsequently being
B) reacted with aminoalkyltrialkoxysilanes by at least partial reaction and opening of epoxy groups of the glycidyl (meth)acrylate copolymer.

The polymerization time to glycidyl (meth)acrylate copolymers is typically chosen such temperature that the half-life of the initiators used is in the range from 5 min to 10 hours.

The polymerization is preferably carried out at 40 to 180° C.

The reaction time is preferably in the range from 1 to 48 hours.

The reaction is preferably carried out in inert solvents, such as toluene, ethyl acetate, butyl acetate, MPA, xylene, isopropanol, butanol, using 0.1 to 2 parts by weight of solvent, and based on the amount of the components a) to d) to be polymerized.

The reaction can be carried out as a batch operation, as a continuous operation or preferably as a semi-batch operation (metered addition of reactants). The components a) to d) can be metered individually or as mixtures.

Component a) comprises glycidyl methacrylate with or without glycidyl acrylate, preferably just glycidyl methacrylate.

Component b) comprises the acrylic or methacrylic esters of aliphatic C1-C22 mono-ols, cycloaliphatic C5-C27 mono-ols or araliphatic C7-C14 mono-ols, or tetrahydrofurfuryl alcohol or (poly)ethylene glycol monomethyl ether. Useful vinyl monomers further include styrene, alpha-methylstyrene, 3- or 4-methylstyrene, vinyl acetate, vinyl esters or acrylonitrile.

Component c) comprises mercaptopropyltrialkoxysilanes, preferably mercaptopropyltrimethoxysilane.

Component d) comprises azo compounds, such as AIBN, or peroxides, such as benzoyl peroxide, per-esters, ditert-butyl peroxide, cumyl peroxide, ketone peroxides or percarbonic esters.

The glycidyl methacrylate copolymer is preferably formed using

10% to 30% by weight of glycidyl methacrylate with or without glycidyl acrylate
53% to 84.8% by weight of vinyl monomers
5% to 15% by weight of mercaptosilanes and
0.2% to 2% by weight of free-radical initiators.

It is preferably aminopropyltrialkoxysilanes and more preferably aminopropyltrimethoxysilanes which are used in B).

The addition in stage B) can take place alone or dissolved in solvents, such as toluene, ethyl acetate, butyl acetate, MPA, xylene, isopropanol, butanol. The reaction temperature is in the range from 15 to 50° C. and the reaction time is in the range from 30 minutes to 7 days.

The ratio of primary amino groups in the aminoalkyltrialkoxysilanes to epoxy groups in the polymer obtained from A) is preferably in the range from 1.2 to 5 and more preferably in the range from 1.4 to 2.4.

The invention further provides the alkoxysilyl-containing polymers and also varnishes thus obtainable and also the coating compositions obtainable therefrom and comprising these.

These coating compositions preferably further comprise 0% to 5% by weight and preferably 0.1% to 3% by weight of catalysts, such as sulphonic acid or tin compounds.

In use, the coating compositions are applied to a substrate by spraying, blade coating or dipping, preferably by spraying, and dried at temperatures of 15 to 250° C. for 1 minute to 7 days.

This invention further provides coatings obtainable by using the alkoxysilyl-containing polymers of the invention.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

All percentages are by weight, unless otherwise stated.

### Example 1

A flask is charged with 142 g of glycidyl methacrylate, 100 g of methyl methacrylate, 158 g of butyl acrylate, 400 g of isopropanol, 40 g of mercaptopropyltrimethoxysilane and 4 g of AIBN by dropwise addition at 80° C. over 2 h before stirring for 4 h. Then, after cooling to below 30° C., 300 g of aminopropyltrimethoxysilane and 300 g of isopropanol are added dropwise and left to stand at 25° C. for 7 days.

### Example 2

A flask is charged with 142 g of glycidyl methacrylate, 458 g of butyl acrylate, 600 g of isopropanol, 40 g of mercaptopropyltrimethoxysilane and 4 g of AIBN by dropwise addition at 80° C. over 2 h before stirring for 4 h. Then, after cooling to below 30° C., 300 g of aminopropyltrimethoxysilane and 300 g of isopropanol are added dropwise and left to stand at 25° C. for 7 days.

### Example 3

A flask is charged with 142 g of glycidyl methacrylate, 258 g of butyl acrylate, 400 g of isopropanol, 40 g of mercaptopropyltrimethoxysilane and 4 g of AIBN by dropwise addition at 80° C. over 2 h before stirring for 4 h. Then, after cooling to below 30° C., 300 g of aminopropyltrimethoxysilane and 300 g of isopropanol are added dropwise and left to stand at 25° C. for 7 days.

### Example 4

A flask is charged with 142 g of glycidyl methacrylate, 358 g of butyl acrylate, 500 g of isopropanol, 40 g of mercaptopropyltrimethoxysilane and 4 g of AIBN by dropwise addition at 80° C. over 2 h before stirring for 4 h. Then, after cooling to below 30° C., 300 g of aminopropyltrimethoxysilane and 300 g of isopropanol are added dropwise and left to stand at 25° C. for 7 days.

### Example 5

A flask is charged with 142 g of glycidyl methacrylate, 458 g of methyl acrylate, 600 g of isopropanol, 40 g of mercaptopropyltrimethoxysilane and 4 g of AIBN by dropwise addition at 80° C. over 2 h before stirring for 4 h. Then, after cooling to below 30° C., 300 g of aminopropyltrimethoxysilane and 300 g of isopropanol are added dropwise and left to stand at 25° C. for 7 days.

### Performance Testing:

The varnishes of Examples 1, 2, 4 and 5 were admixed with 2% of dodecylbenzenesulphonic acid (DBS), adjusted to a solids content of 35% with ethyl acetate and sprayed on a Sata HVLP Minijet spraying machine at 1 bar pressure in 5 spray passes. RT is room temperature, and a petrol resistance of 0 is very good and of 5 is poor. The forced drying at 50° C. was carried out in a water vapour-saturated atmosphere. The following results were obtained:

| Example | 1 | 2 | 4 | 5 |
|---|---|---|---|---|
| Layer thickness | | | | |
| [μ] | 35 | 30 | 35 | 30 |
| Pendulum | | | | |
| hardness | | | | |
| RT 1 d | 94 | 46 | 48 | 39 |
| RT 7 d | 130 | 67 | 87 | 85 |
| 1 d + 16 h 50° C. | 144 | 48 | 57 | 85 |
| 7 d + 16 h 50° C. | 157 | 60 | 89 | 87 |
| Petrol resistance | | | | |
| RT 1 d | 0 | 3 | 0 | 0 |
| RT 7 d | 0 | 1 | 0 | 0 |
| 1 d + 16 h 50° C. | 0 | 2 | 0 | 0 |
| 7 d + 16 h 50° C. | 0 | 0 | 0 | 0 |

### Comparative Example

Example 1 is repeated except that 40 g of dodecyl mercaptan were used as regulator instead of 40 g of mercaptopropyltrimethoxysilane. Performance testing was carried out as described above, a 30 μm thick film being obtained with the following values:

### Pendulum Hardness

| | |
|---|---|
| RT 1 d | 34 |
| RT 7 d | 70 |
| 1 d + 16 h 50° C. | 75 |
| 7 d + 16 h 50° C. | 87 |

### Petrol Resistance

| | |
|---|---|
| RT 1 d | 5 |
| RT 7 d | 3 |
| 1 d + 16 h 50° C. | 3 |
| 7 d + 16 h 50° C. | 1 |

The use of a silyl-free regulator is seen to lead to worse crosslinking (hardness and petrol resistance).

1. A process for preparing alkoxysilyl-containing polymers, comprising
A) Preparing a glycidyl (meth)acrylate copolymer by polymerizing
a) 5% to 40% by weight of glycidyl methacrylate, which is optionally mixed with glycidyl acrylate;
b) 50% to 93.9% by weight of vinyl monomers;
c) 1% to 20% by weight of mercaptosilanes; and
d) 0.1% to 5% by weight of free-radical initiators; and
B) reacting said glycidyl (meth)acrylate copolymer with aminoalkyltrialkoxysilanes by at least partial reaction and opening of epoxy groups of the glycidyl (meth)acrylate copolymer.

2. The process of claim 1, wherein said vinyl monomers b) comprise acrylic or methacrylic esters of aliphatic C1-C22 mono-ols, cycloaliphatic C5-C27 mono-ols or araliphatic C7-C14-mono-ols, tetrahydrofurfuryl alcohol or (poly)ethylene glycol monomethyl ether, styrene, alpha-methylstyrene, 3- or 4-methylstyrene, vinyl acetate, vinyl esters, or acrylonitrile.

3. The process of claim 1, wherein c) comprises mercaptopropyltrimethoxysilane.

4. The process of claim 1, wherein said aminoalkyltrialkoxysilanes of B) comprise aminopropyltrialkoxysilanes.

5. The process of claim 1, wherein the ratio of primary amino groups in said aminoalkyltrialkoxysilanes of B) to epoxy groups in said glycidyl (meth)acrylate copolymer obtained in A) is in the range of from 1.2 to 5.

6. An alkoxysilyl-containing polymer prepared by the process of claim 1.

7. A coating composition comprising at least one alkoxysilyl-containing polymer of claim 6.
